(19) United States
(12) Patent Application Publication
(10) Pub. No.: US 2010/0287009 A1
(43) Pub. Date: Nov. 11, 2010

(54) DISCOUNTED RESTAURANT RESERVATION DISTRIBUTION SYSTEM

(76) Inventor: Mitchell J. Francis, Beverly Hills, CA (US)

Correspondence Address: WELSH & FLAXMAN LLC, 2000 DUKE STREET, SUITE 100, ALEXANDRIA, VA, 22314, US

(21) Appl. No.: 12/837,043

(22) Filed: Jul. 15, 2010

Related U.S. Application Data
(63) Continuation of application No. 10/327,612, filed on Dec. 24, 2002, now abandoned.
Application No. 10/327,612 is a continuation of application No. 10/627,612, filed on Jul. 28, 2003, now Pat. No. 7,010,310.

(51) Int. Cl. G06Q 10/00; G06Q 30/00

(52) U.S. Cl. 705/5

(57) ABSTRACT

A system is provided for marketing restaurant reservations during non-peak periods by offering promotions through a central distribution system. The system includes a central distribution processor to which consumers are provided access for determining the availability of discounted restaurant reservations and purchasing discounted restaurant reservations. The system also includes a plurality of remote restaurants linked to the central distribution processor, the remote restaurants including interface software compatible with the central distribution processor for facilitating the uploading of relevant discounted restaurant reservations to the central distribution processor. The interface software further provides a user interface through which the plurality of remote restaurants selectively enter available discounted restaurant reservation information which is subsequently uploaded to the central distribution processor for access and purchase by consumers.

### CROSS-REFERENCE TO RELATED APPLICATIONS

This U.S. Patent Application is based upon U.S. Provisional Patent Application Ser. No. 60/342,097, filed Dec. 26, 2001, and entitled “Discounted Restaurant Distribution System”.

### BACKGROUND OF THE INVENTION

1. Field of the Invention

The invention relates to a system providing consumers with discounted restaurant reservations.

2. Description of the Prior Art

Many businesses operate in a “use it or lose it” environment in which services are placed in the public domain and are forever wasted if a consumer does not take advantage of the service being offered. For example, theatrical performances are generally scheduled for a specific time and go on whether the house is full or empty. Any unused and/or unsold seats represent a total loss. The loss associated with the unused or unsold seats may not be recouped, since the cost of the production is substantially the same whether that seat is or is not used.

Similarly, the costs associated with the operation of a restaurant are substantially the same whether every table is filled for the entire evening or not. That is, the restaurant owner is responsible for paying the staff, utilities and other expenses associated with the operation of a restaurant whether the restaurant is full or not. In fact, food costs associated with a specific meal are minimal when the overall operating costs of a restaurant are considered. Use of these tables, even when food is discounted, would result in a benefit to the restaurant when compared to total non-use commonly encountered during low volume times. For example, profit is made on the discounted meal, wait staff receives additional tips and beverage expenses add to the overall gross income of the restaurant.

As such, both restaurants and theaters attempt various marketing techniques to ensure that their facilities are optimally utilized. Despite these efforts, they are not always successful in optimally making use of their facilities. The present invention provides a system aiding both restaurants and theaters in respectively marketing unused reservations and tickets.

### SUMMARY OF THE INVENTION

It is, therefore, an object of the present invention to provide a system for marketing restaurant reservations during non-peak periods by offering promotions through a central distribution system. The system includes a central distribution processor to which consumers are provided access for determining the availability of discounted restaurant reservations and purchasing discounted restaurant reservations. The system also includes a plurality of remote restaurants linked to the central distribution processor, the remote restaurants including interface software compatible with the central distribution processor for facilitating the uploading of relevant discounted restaurant reservations to the central distribution processor. The interface software further provides a user interface through which the plurality of remote restaurants selectively enter available discounted restaurant reservation information which is subsequently uploaded to the central distribution processor for access and purchase by consumers.

It is also an object of the present invention to provide a system wherein the consumer pays a reservation fee to an operator of the system.

It is another object of the present invention to provide a system wherein the restaurants pay the operator a fee based upon the sale of discounted restaurant reservations.

It is a further object of the present invention to provide a system wherein the user interface includes a seating chart display through which a restaurant employee enters discounted reservation information.

It is yet another object of the present invention to provide a system including a reservation information and sales site at which consumers may access the central distribution processor for purchasing discounted restaurant reservations.

It is still another object of the present invention to provide a method for marketing restaurant reservations through a central distribution system. The method is achieved by establishing a central distribution processor which stores information concerning the availability of restaurant reservations, installing interface software compatible with the central distribution processor at a plurality of remote restaurants (the interface software facilitating the uploading of relevant restaurant reservation information to the central distribution processor), entering available restaurant reservation information at the remote restaurant via a user interface associated with the interface software (the user interface permitting the plurality of remote restaurants to selectively enter available reservation information for uploading to the central distribution processor), uploading the restaurant reservation information to the central distribution processor and providing consumers with access to the central distribution processor for determining the availability of restaurant reservations and purchasing discounted restaurant reservations.

It is yet a further object of the present invention to provide a system for marketing restaurant reservations through a central distribution system. The system includes a central distribution processor to which consumers are provided access for determining the availability of restaurant reservations and purchasing restaurant reservations. The system further includes a plurality of remote restaurants linked to the central distribution processor, the remote restaurants including interface software compatible with the central distribution processor for facilitating the uploading of relevant restaurant reservations to the central distribution processor. The interface software further provides a user interface through which the plurality of remote restaurants selectively enter available restaurant reservation information which is subsequently uploaded to the central distribution processor for access and purchase by consumers.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a schematic of the present system.

FIG. 2 is an exemplary interface screen in accordance with the present invention.

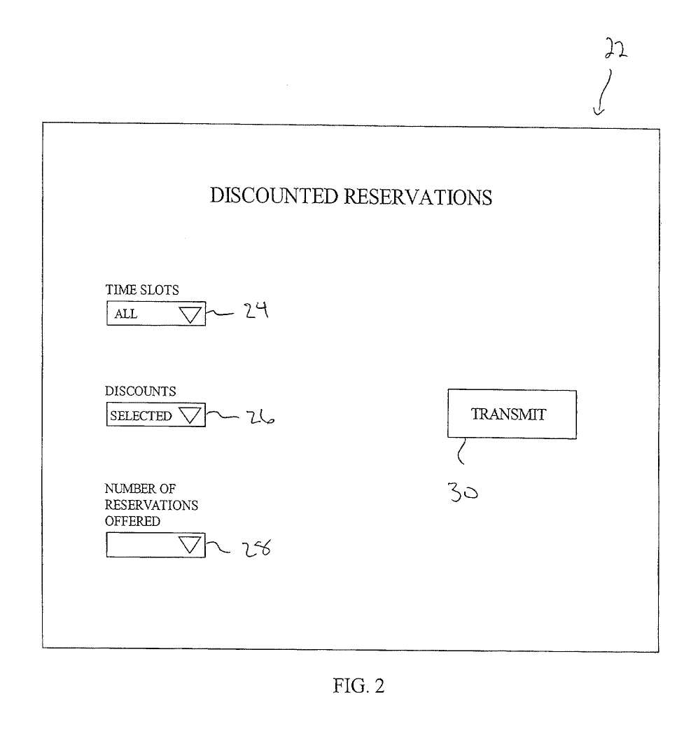

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as the basis for the claims and as a basis for teaching one skilled in the art how to make and/or use the invention.

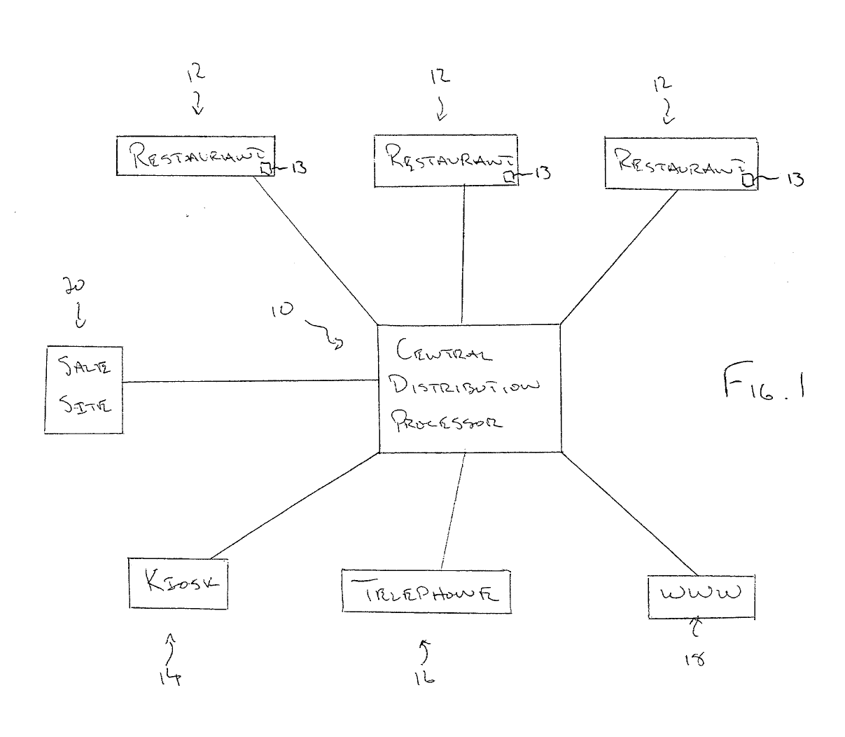

With reference to FIG. 1, a system for the distribution of discounted restaurant reservations is disclosed. The systems includes a central distribution processor 10 linked to a plurality of restaurants 12, permitting consumers to obtain restaurant reservations with discounted meals, and other promotions. The discounted reservations offered by this system are primarily designed to attract consumers to restaurants during non-peak times. For example, the discounted reservations may include a 2 for 1 deal, 50% off deal, half price entre deal, etc., when the consumer eats at a low volume time.

In particular, and as discussed above in the Background of the Invention, restaurants commonly encounter low volume at times before and after the most popular meal times. Since restaurants are open during these time, and are therefore paying staff, utilities and other expenses associated with the operation of a restaurant, any unused tables during these periods are wasted. Use of these tables, even when food is discounted, would result in a benefit to the restaurant when compared to total non-use commonly encountered during low volume times. As such, the present system provides restaurants with a mechanism by which they may entice consumers to eat at their restaurant during low volume periods.

Specifically, and as applied to the marketing of restaurant reservations, the system includes a central distribution processor 10 which monitors, maintains and provides access to information regarding the availability of discounted restaurant reservations. In accordance with a preferred embodiment of the present invention, consumers are provided access to the information maintained in the central distribution process 10 via a kiosk 14, telephone 16, global communication network 18 (e.g., WWW), or other patron interface, through which patrons may browse available discounted restaurant reservations. Although the communication systems described above are generally wire based, communication may be achieved via wireless systems as may be developed in the future.

The system further includes a plurality of remote and distinct restaurants 12 linked to the central distribution processor 10. The restaurants 12 are provided with computer communication equipment, including interface software 13 compatible with the central distribution processor 10, for facilitating the uploading of relevant discounted reservation information to the central distribution processor 10. The interface software 13 further provides a user interface 22 through which the plurality of restaurants selectively enter available reservation and discount information, which is subsequently uploaded to the central distribution processor 10 for access and purchase by consumers.

Although it is contemplated that the central distribution processor 10 may be accessed via telephone or via the Internet, in accordance with a preferred embodiment of the present invention the central distribution processor 10 is maintained at, or in association with, a reservation information and sales site 20. The reservation information and sales site 20 provides consumers with a convenient location at which they may gather reservation information and/or purchase available reservations/discounts. The reservation information and sales site 20 is further provided with a plurality of computer terminals operated by employees of the company operating the present system. The reservation information and sales site 20 is also provided with an information board upon which available reservations, and associated discounts, are listed for convenient review by consumers in the vicinity of the reservation information and sales site 20.

Based upon the preferred set up for the reservation information and sales site 20, a consumer is provided ready access to ascertain available reservations and associated discounts, and to purchase the same from a system employee. Reservation information may be retrieved by either personally consulting with an employee operating a computer terminal directly linked to the central distribution processor 10 or merely reviewing the information presented on the information board positioned for easy access by consumers in the vicinity of the reservation information and sales site 20.

In an effort to provide consumers with information regarding the various restaurants for which reservations are available, the reservation information and sales site 20 is further provided with computer monitors displaying the menus and reviews for the participating restaurants. Written literature regarding the various restaurants is also made available to consumers requiring information before deciding upon which restaurant to visit.

As mentioned above, the central distribution processor 10 is linked to a plurality of remote restaurants 12 via computers located at the restaurants. Facilitating communication between the various restaurants 12 participating in the present system and the central distribution processor 10 is an interface software 13 compatible with the central distribution processor 10. The interface software 13 is loaded on a computer at each of the remote restaurants 12 and permits these restaurants to conveniently and reliable transmit reservation/discount information to the central distribution processor 10 such that the discounted reservations are immediately made available to consumers taking advantage of the present system.

In accordance with a preferred embodiment of the present invention, the interface software 13 directs employees of the remote restaurants on entering discounted reservations in such a way that the discounted reservation information is formatted by the interface software. The formatted information is then transmitted for ready use by the central distribution processor 10. In accordance with a preferred embodiment of the present invention, the interface screen 22 is provided with menus for selecting time slots for specific reservations and the various discounts associated with the designated reservations. Fir example, the interface screen may be provided with drop down menus relating to TIME SLOTS 24, DISCOUNTS 26 and NUMBER OF RESERVATIONS OFFERED 28. Once the various parameters of the offered reservations are set, the restaurant employee need only press the TRANSMIT 30 button.

In this way, the remote restaurant employee need only pick specific times for which he or she wishes to designate available discounted reservations to be made available via the present system and click upon the specific reservation times shown on the interface to designate those unused reservations the restaurant wishes to make available through the present system. Once the restaurant employee selects to the designated reservations and discounts, the information is formatted and transmitted to the central distribution processor 10. While a preferred embodiment utilizes a computer network for transmitting information to the central distribution processor, it is contemplated that the information may be transmitted in other ways, for example, via facsimile, or other electronic communication mechanisms.

It is contemplated that the reservation/discount information will be made available to consumers on a regular basis with the discounted reservation information being released on a daily or weekly basis at a predetermined time before a specific restaurant seating. However, since remote restaurants have control over when to release discounted reservations via the interface software, the remote restaurants may choose to release reservations throughout a given day if they find such a distribution technique enhances overall use of the various reservations.

It should be understood that the present system links a variety of distinct, unrelated restaurants through the application of the interface software described above. The present system, therefore, does not require that the distinct restaurants operate in a similar manner or that the distinct restaurants form a type of affiliation. Rather, the use of the present interface software in conjunction with the central distribution processor allows these distinct restaurants to operate independently, while permitting the restaurants to readily distribute discounted reservations when it is determined they may go to waste via sales through the restaurant's own marketing.

From a business perspective, it is contemplated that both the consumer and remote restaurant will pay the operator of the present system a fee for the use of the present system. Specifically, it is contemplated that the consumer will pay a reservation fee and the remote restaurant is responsible for paying the system operators a fee based upon the value of the discounted reservation sold via the present system.

In addition to the distribution of discounted restaurant reservations, it is contemplated that the present system may be employed in other “use it or lose it” business. For example, it is contemplated the present system may be employed in the marketing of discounted golf tee times.

It is further contemplated that the present invention may similarly be applied in the distribution of premium restaurant reservations for which patrons will be expected to pay a premium reservation fee. This service would be applied for restaurants which are very difficult to get into, and, as such, consumers would be willing to pay a reservation fee to avoid the wait common at many very popular restaurants. Such a system would be implemented in much the same manner as the discounted distribution system described above. For example, the contemplated system includes a central distribution processor which monitors, maintains and provides access to information regarding the availability of premium restaurant reservations. The premium restaurant reservations for sale by the present system are released via the participating restaurants and this information is forwarded to the central distribution processor in the manner described above with regard to the release of discounted restaurant reservations. As discussed above, the participating restaurants linked to the central distribution processor include interface software compatible with the central distribution processor for facilitating the uploading of relevant reservation information to the central distribution processor. The interface software further provides a user interface through which the plurality of participating restaurants selectively enter available reservation information which is subsequently uploaded to the central distribution processor for access and purchase by restaurant patrons.

The consumers are ultimately provided access to the premium reservation information maintained in the central distribution processor via a kiosk, or other patron interface, at which patrons may browse and purchase available restaurant reservation.

While the preferred embodiments have been shown and described, it will be understood that there is no intent to limit the invention by such disclosure, but rather, is intended to cover all modifications and alternate constructions falling within the spirit and scope of the invention as defined in the appended claims.

1-15. (canceled)

16. A system for marketing restaurant reservations by offering discounted meals through a central distribution system, comprising:
a central distribution processor to which consumers are provided access for determining availability of restaurant reservations and discounted meals;
a plurality of remote restaurants linked to the central distribution processor, each of the remote restaurants including a computer with interface software compatible with the central distribution processor for facilitating uploading of relevant restaurant reservations and discounted meals to the central distribution processor;
the interface software further provides a user interface through which the plurality of remote restaurants selectively enter available restaurant reservation and discounted meal information which is subsequently uploaded to the central distribution processor for-access and purchase by consumers;
wherein a consumer pays a reservation fee to an operator of the system or the restaurants pay an operator of the system a fee.

17. A method for marketing restaurants through a central distribution system, comprising the following steps:
establishing a central distribution processor which stores information concerning availability of restaurant reservations and discounted meals;
installing interface software compatible with the central distribution processor at a plurality of remote restaurants, the interface software installed at each of the restaurants facilitates uploading of restaurant reservation and discounted meal information to the central distribution processor;
entering available restaurant reservation and discounted meal information at the remote restaurant via a user interface associated with the interface software, the user interface permitting the plurality of remote restaurants to selectively enter available restaurant reservation and discounted meal information for uploading to the central distribution processor for access;
uploading the restaurant reservation and discounted meal information to the central distribution processor; and
providing consumers with access to the central distribution processor for determining the availability of restaurant reservations and discounted meals
charging a consumer a reservation fee when a restaurant reservation is purchased or charging the restaurant a fee.

18. A system for marketing restaurants through a central distribution system, comprising:
a central distribution processor to which consumers are provided access for determining availability of restaurant reservations and discounted meals;
a plurality of remote restaurants linked to the central distribution processor, each of the remote restaurants including a computer with interface software compatible with the central distribution processor for facilitating uploading of relevant restaurant reservations and discounted meal to the central distribution processor;
the interface software further provides a user interface through which the plurality of remote restaurants selectively enter available restaurant reservation and discounted meal information which is subsequently uploaded to the central distribution processor for access and purchase by consumers.
